(19) United States
(12) Patent Application Publication
(10) Pub. No.: US 2015/0050963 A1
(43) Pub. Date: Feb. 19, 2015

(54) ELECTRONIC DEVICE WITH POWER SHARING CAPABILITIES AND METHODS THEREFOR

(71) Applicant: MOTOROLA MOBILITY LLC, Libertyville, IL (US)

(72) Inventors: Daniel S. Rokusek, Long Grove, IL (US); Guy R. Griffin, Pleasant Prairie, WI (US); David B. Harris, Wheaton, IL (US); Roshan Kamath, Hainesville, IL (US)

(73) Assignee: MOTOROLA MOBILITY LLC, Libertyville, IL (US)

(21) Appl. No.: 14/055,107

(22) Filed: Oct. 16, 2013

Related U.S. Application Data
(60) Provisional application No. 61/865,818, filed on Aug. 14, 2013.

(51) Int. Cl. G06F 1/26; H04L 29/08

(52) U.S. Cl. CPC G06F 1/266; H04L 67/22
USPC 455/566

(57) ABSTRACT

Methods and devices for sharing energy between devices are provided. For example, an electronic device (100) can include a control circuit (504) and an energy storage device (301) operable with the control circuit. The electronic device can include a power interface (201) operable with the energy storage device and a user interface, such as a control button (303), that is operable with the control circuit. The control circuit can determine another device (601) is coupled to the power interface, and can detect user input occurring at the user interface for at least a predetermined duration (701). In response, the control circuit can cause the energy storage device to deliver a portion of energy stored therein to the another device through the power interface.

### BACKGROUND

1. Technical Field

This disclosure relates generally to devices, and more particularly to electronic devices operable with energy storage devices.

2. Background Art

Portable electronic devices, such as cellular telephones, laptop computers, tablet computers, pagers, and two-way radios for example, derive their portability from batteries having rechargeable cells. These batteries allow these devices to slip the surly bonds of wired power connections to travel with users wherever they may go. A typical battery disposed within one of these devices includes one or more electrochemical cells that may be charged and discharged to power the device. The user couples the device to a charger, which is generally tethered to a wall via a power cord, to charge the device. The user can then detach the device from the charger to portably use the device until the battery is depleted. When the battery becomes unexpectedly depleted, it can be frustrating. This is particularly true due to the daily reliance people increasingly place upon their personal devices.

It would be advantageous to have a device, system, or method capable of remedying situations in which a battery of an electronic device becomes unexpectedly depleted.

### BRIEF DESCRIPTION OF THE DRAWINGS

FIG. 1 illustrates an explanatory device in accordance with one or more embodiments of the disclosure.

FIG. 2 illustrates an explanatory device in accordance with one or more embodiments of the disclosure.

FIG. 3 illustrates an explanatory device in accordance with one or more embodiments of the disclosure.

FIG. 4 illustrates an explanatory device in accordance with one or more embodiments of the disclosure.

FIG. 5 illustrates an explanatory device in accordance with one or more embodiments of the disclosure.

FIG. 6 illustrates an explanatory system and method in accordance with one or more embodiments of the disclosure.

FIG. 7 illustrates an explanatory device and method in accordance with one or more embodiments of the disclosure.

FIG. 8 illustrates an explanatory device and method in accordance with one or more embodiments of the disclosure.

FIG. 9 illustrates an explanatory method in accordance with one or more embodiments of the disclosure.

FIG. 10 illustrates an explanatory method in accordance with one or more embodiments of the disclosure.

FIG. 11 illustrates an explanatory method in accordance with one or more embodiments of the disclosure.

FIG. 12 illustrates various embodiments of the disclosure.

FIG. 13 illustrates an alternate device in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to power and energy sharing between electronic devices in response to user input at one device. Any process descriptions or blocks in flow charts should be understood as representing modules, segments, or portions of code that include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of sharing power between devices in response to user input as described herein. The non-processor circuits may include, but are not limited to, a radio receiver, a radio transmitter, signal drivers, clock circuits, power source circuits, and user input devices. As such, these functions may be interpreted as steps of a method to perform power sharing in response to user input. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide devices, systems, and methods that allow users to quickly and conveniently share energy between devices. In one embodiment, the user can share only a portion of the energy from a charged or partially charged device with another device, thereby preventing the sharing device from fully depleting the energy storage device of the shared device. User instructions may be input that allow the user on control the amount of energy shared. For example, in one embodiment the user can limit the amount of energy by defining an amount of power that may flow for an amount of time. In another embodiment, the user can limit the amount of energy by defining a percentage of charge to remain in the energy storage device of the shared device. In some embodiments, the user instructions can preclude energy sharing when the energy storage device has a state of charge that is below a predetermined threshold. In one or more embodiments, the user can selectively actuate or deactivate an energy-sharing mode of operation, thereby allowing or preventing energy sharing from the device.

In one embodiment, a device includes a control circuit. An energy storage device is operable with the control circuit, and alternatively, can power the control circuit. A power interface is operable with the energy storage device. In one embodiment, the power interface is a wired connector. In one embodiment, the power interface is a mini-USB (Universal Serial Bus) connector. In one embodiment, the power interface is stowable within the housing of the device when not in use. In other embodiments, the power interface comprises a wireless interface for communicating, and or delivering or receiving power, to and from another device.

In one embodiment, a user interface is operable with the control circuit. For example, in one embodiment the user interface comprises a control button. A user can touch the control button to actuate it when the control button is touch sensitive. A user can press the control button to actuate it when the control button is a conventional push-button switch.

In one embodiment, the control circuit is to determine another device coupled to the power interface. The control circuit can then detect user input occurring continuously at the user interface for at least a predetermined duration. For example, where the control button is a push-button switch, in one embodiment the control circuit can determine when a user presses and holds down the control button switch for at least a predetermined time, such as for at least three seconds. When this occurs, i.e., in response the user input occurring continuously for the predetermined duration, the control circuit can cause the energy storage device to deliver a portion of energy stored therein to another device through the power interface. In one embodiment, the control circuit is to receive user-selectable options defining how much energy is to be shared with another device. For example, the amount can be limited to a predefined amount of power for a predetermined time, a total amount of energy to transfer, a percentage of stored energy, or combinations thereof.

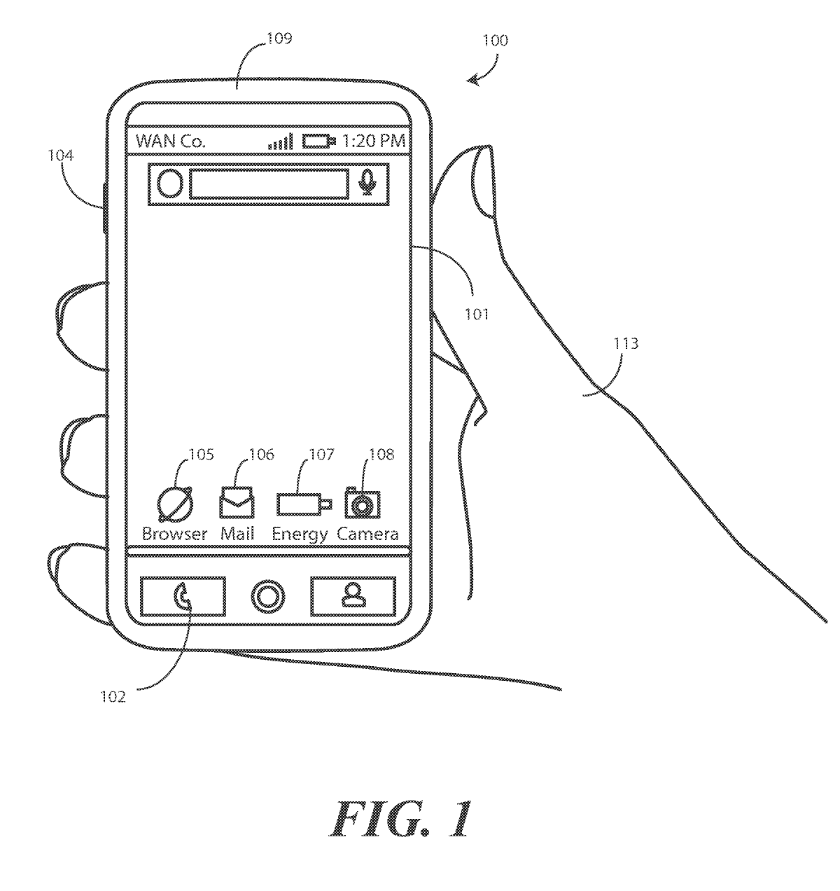

Turning now to FIGS. 1-4, illustrated therein is one explanatory electronic device 100 configured in accordance with one or more embodiments of the disclosure. The explanatory electronic device 100 of FIG. 1 is shown as a smart phone for illustrative purposes. However, it will be obvious to those of ordinary skill in the art having the benefit of this disclosure that other electronic devices may be substituted for the explanatory smart phone of FIG. 1. For example, the electronic device 100 may be configured as a palm-top computer, a tablet computer, a gaming device, wearable computer, a media player, or other device.

A user 113 is holding the electronic device 100. The operating system environment, which is configured as executable code operating on one or more processors or control circuits of the electronic device 100, has associated therewith various applications or “apps.” Examples of such applications shown in FIG. 1 include a cellular telephone application 102 for making voice telephone calls, a web browsing application 105 configured to allow the user 113 to view webpages on the touch-sensitive display 101 of the electronic device 100, an electronic mail application 106 configured to send and receive electronic mail, and a camera application 108 configured to capture still (and optionally video) images. These applications are illustrative only, as others will be obvious to one of ordinary skill in the art having the benefit of this disclosure.

The electronic device 100 also includes an energy sharing application 107. In one or more embodiments, activation of the energy sharing application 107 allows the user 113 to share energy stored within an energy storage device 301 with another device via a power interface 201. In one embodiment, the user 113 can enter instructions and other control data into the energy sharing application 107 to control how, if, and/or when energy is shared with other devices. For example in one embodiment, the user 113 can enter user instructions into the energy sharing application 107 to limit the amount of energy that can be shared with another device to permit the energy sharing application 107 from consuming all of the energy stored in the energy storage device 301, which in this embodiment is a rechargeable electrochemical battery. In another embodiment, the user 113 can enter user instructions to control the energy sharing application 107 to define how much energy is to be shared with another device. These user instructions can include the amount of energy to be shared as a function of time, as a function of the state of charge of the energy storage device 301, a percentage of remaining energy stored within the energy storage device 301, or combinations thereof. In one or more embodiments, the energy sharing application 107 provides the user 113 with an easy way to activate and/or deactivate the shared power functionality of the electronic device 100. In other embodiments, the energy sharing application 107 provides the user 113 with a convenient way to see whether the application is in operation or is not actively in operation. In yet another embodiment, the user can enter user instructions into the energy sharing application 107 to define just what other devices are permitted to share energy with the electronic device 100. Illustrating by example, the user instructions defining what other devices are permitted to share energy can be defined by device identifiers, e.g., serial numbers, service identifiers, e.g., telephone numbers or email addresses, or social identifiers, e.g., whether the user of the other device is “friends” or otherwise connected to the user 113. Other identifiers will be obvious to those of ordinary skill in the art having the benefit of this disclosure.

The electronic device 100 includes a touch-sensitive display 101. In one embodiment, the touch-sensitive display 101 is touch-sensitive and is configured as an organic light emitting diode display. However, an organic light emitting diode display is one type of touch-sensitive display 101 suitable for use with the disclosure, and will accordingly be used for explanatory purposes in this disclosure. However, it should be noted that other types of displays, including liquid crystal displays, would be obvious to those of ordinary skill in the art having the benefit of this disclosure.

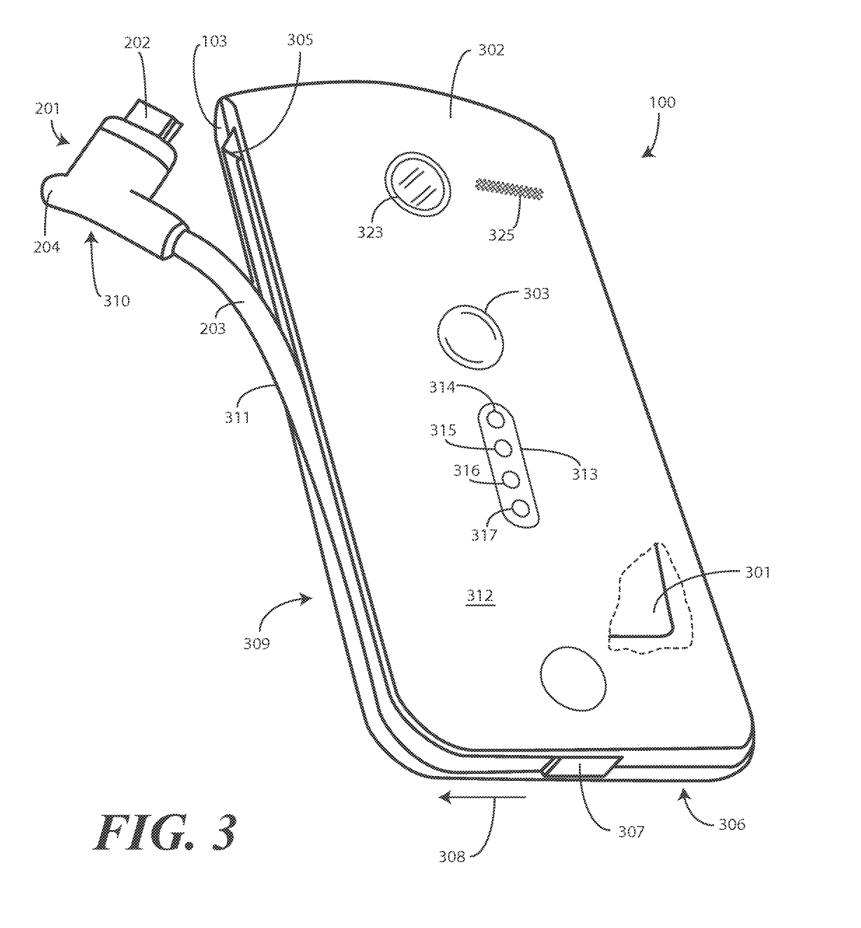

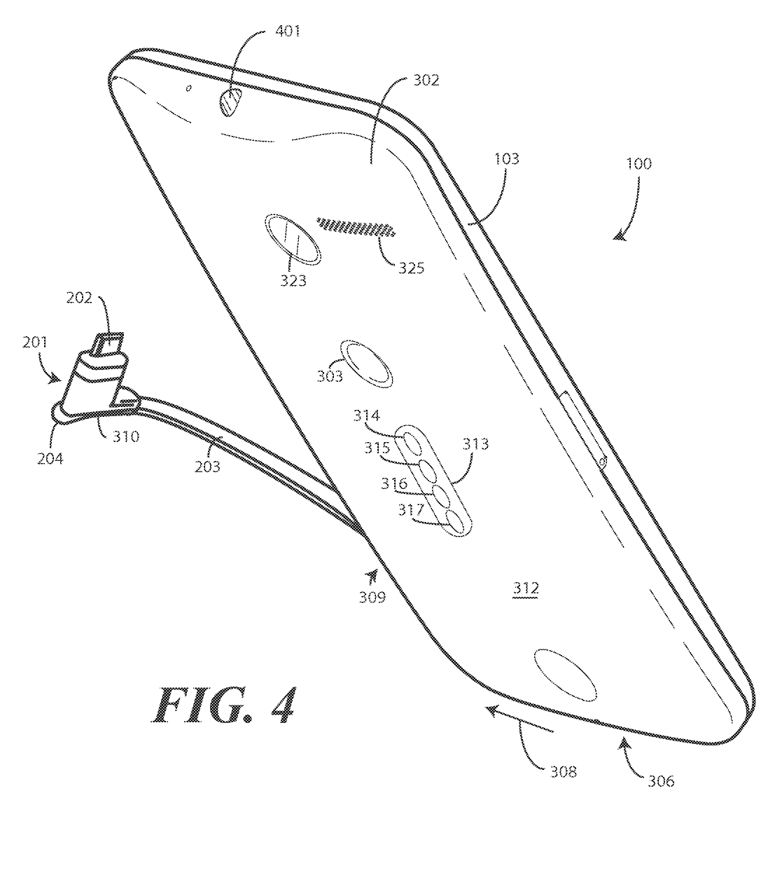

The explanatory electronic device 100 of FIGS. 1-4 includes two housing members. An upper housing member 103 is disposed about the periphery of the touch-sensitive display 101. As shown in FIGS. 3-4, a lower housing member 301 forms the backside of the electronic device 100 in this illustrative embodiment. Features can be incorporated into the housing members, including the control buttons 104,304, a camera 323, speaker port 325, or audio jack 401.

In one or more embodiments, the electronic device 100 includes a power interface 201 that is operable with the energy storage device 301. In this illustrative embodiment, the power interface 201 comprises a mini-USB connector 202 attached to the electronic device 100 by a flexible cable 203. In one embodiment, the power interface 201 can be used to charge the energy storage device 301. In one embodiment, the power interface 201 can be used to deliver energy from the energy storage device 301 as well. For example, in one embodiment, the user 113 can connect another device to the power interface so that energy from the energy storage device 301 can be delivered to the other device. This provides a convenient way for the user 113 to share energy with a friend who may have a device with a depleted battery.

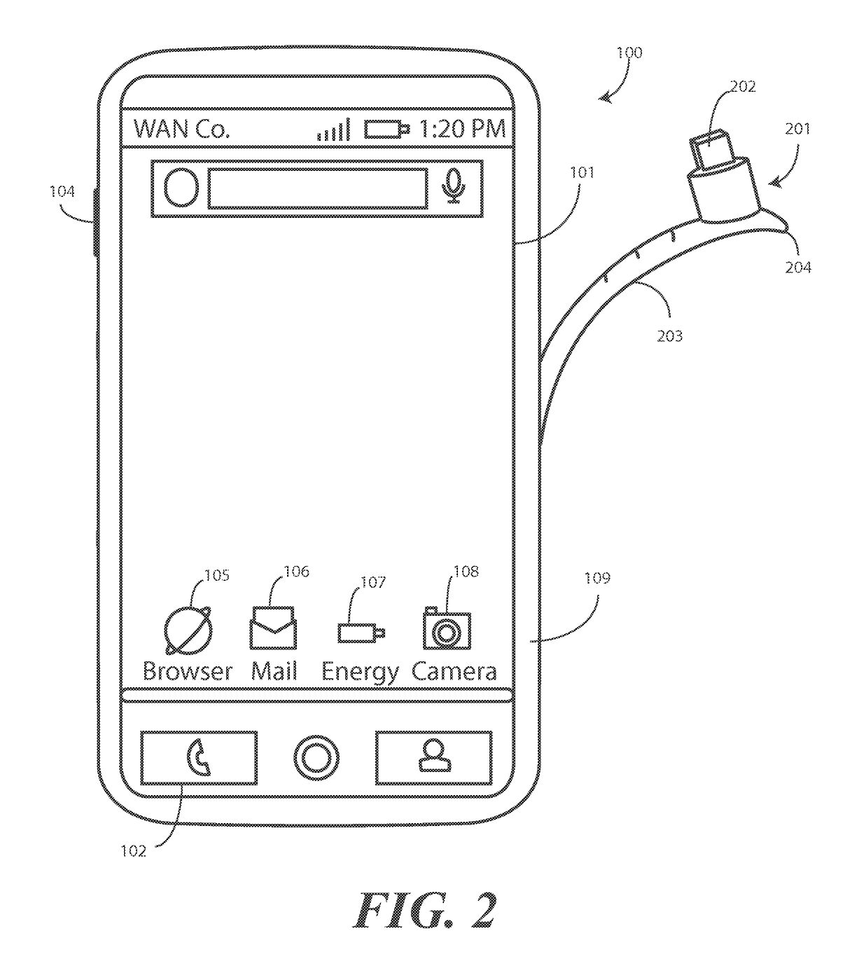

As shown in FIGS. 1 and 3, in one or more embodiments the flexible cable 203 and the power interface 201 are stowable within the housing members 103,301 of the electronic device 100 when not in use. For example, when the user 113 is not sharing energy with a friend's device, or alternatively when the user 113 is not charging their own energy storage device 301, there is no need for the power interface 201 to be dangling from the electronic device 100. Accordingly, in one or more embodiments the user 113 may stow the flexible cable 203 and the power interface 201 into a power interface receiver 305. In the illustrative embodiment of FIG. 3, the flexible cable 203 emanates from the bottom 306 of the electronic device 100. The power interface receiver 305 extends from the connection point 307 along one side 308 of the bottom of the electronic device 100 and up one side 309 of the electronic device 100. When the power interface 201 is inserted into the power interface receiver 305, the exterior 310 of the mini-USB connector 202 and the exterior 311 of the flexible cable 203 define an exterior sidewall 114 of the electronic device 100 that the user 113 can hold, as shown in FIG. 1. However, when the user 113 desires to share energy with another device, they may lift a thumb tab 204 of the mini-USB connector 202 to curl the power interface and flexible cable 203 out of the power interface receiver 305 as shown in FIGS. 2-4. In one or more embodiments, a length of the flexible cable 203 is greater than a length of the side 309 of the electronic device 100 to give the user 113 more flexibility in energy sharing, as the device attached to the power interface 201 need not be too close to the electronic device 100. This length can also conserve power, as the wireless communication circuits in each device do not need to compete with each other to obtain satisfactory efficiency in performance.

In one or more embodiments, the electronic device 100 is configured with only a single control button. In one embodiment, control button 303 defines a user interface capable of physical user actuation by touching or pressing, and is the only such user interface of the electronic device other than the touch-sensitive display 101. As shown in FIGS. 3-4, in this illustrative embodiment the control button 303 in one embodiment is disposed on a side of the device opposite the touch-sensitive display 101. For example, as shown in FIG. 1, the touch-sensitive display 101 is disposed on a first major face 109 of the electronic device 100. The control button 303 of this illustrative embodiment is disposed on a second major face 312 of the electronic device 100, shown in FIGS. 3-4, which is opposite the first major face 109. Other configurations will be obvious to those of ordinary skill in the art having the benefit of this disclosure.

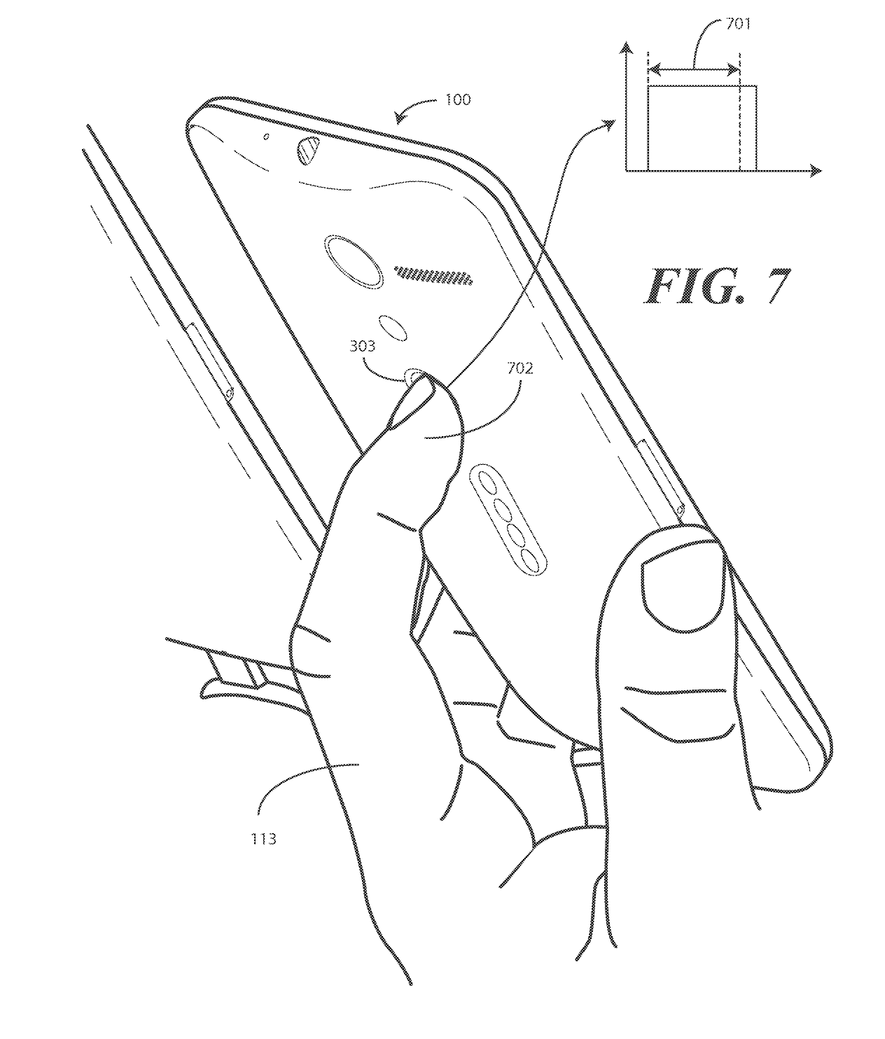

Note that the second major face 312 shown in FIGS. 3-4 is generally convex in that a central portion of the second major face 312 of the electronic device 100 extends outwardly from the electronic device 100, i.e., up, to the right, and out of the page as viewed in FIG. 3, and down, left, and out of the page as viewed in FIG. 4, relative to the side portions of the second major face 312. While this is one configuration of the second major face that is convenient for use by the user 113, as will be shown in more detail with reference to FIG. 7 below, it should be noted that housings of electronic devices employing embodiments of the disclosure can take a variety of shapes, and can be substantially planar, convex, concave, undulating, or combinations thereof.

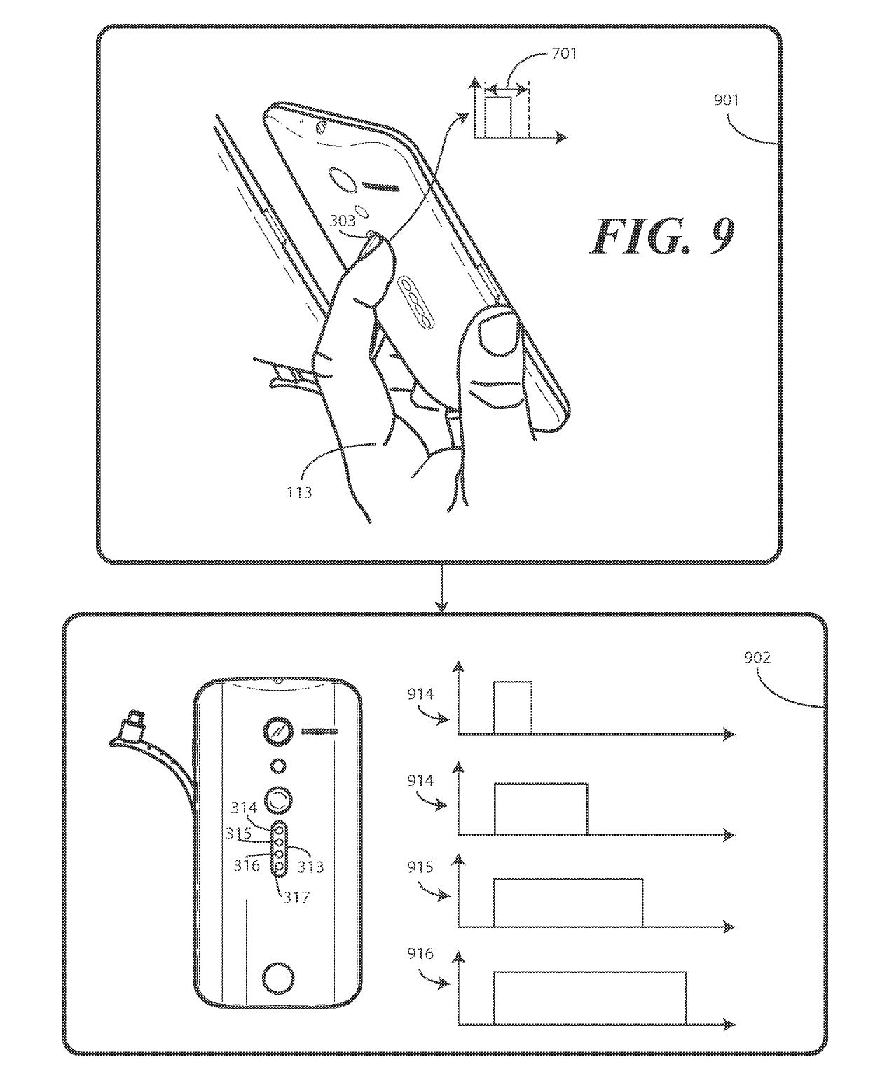

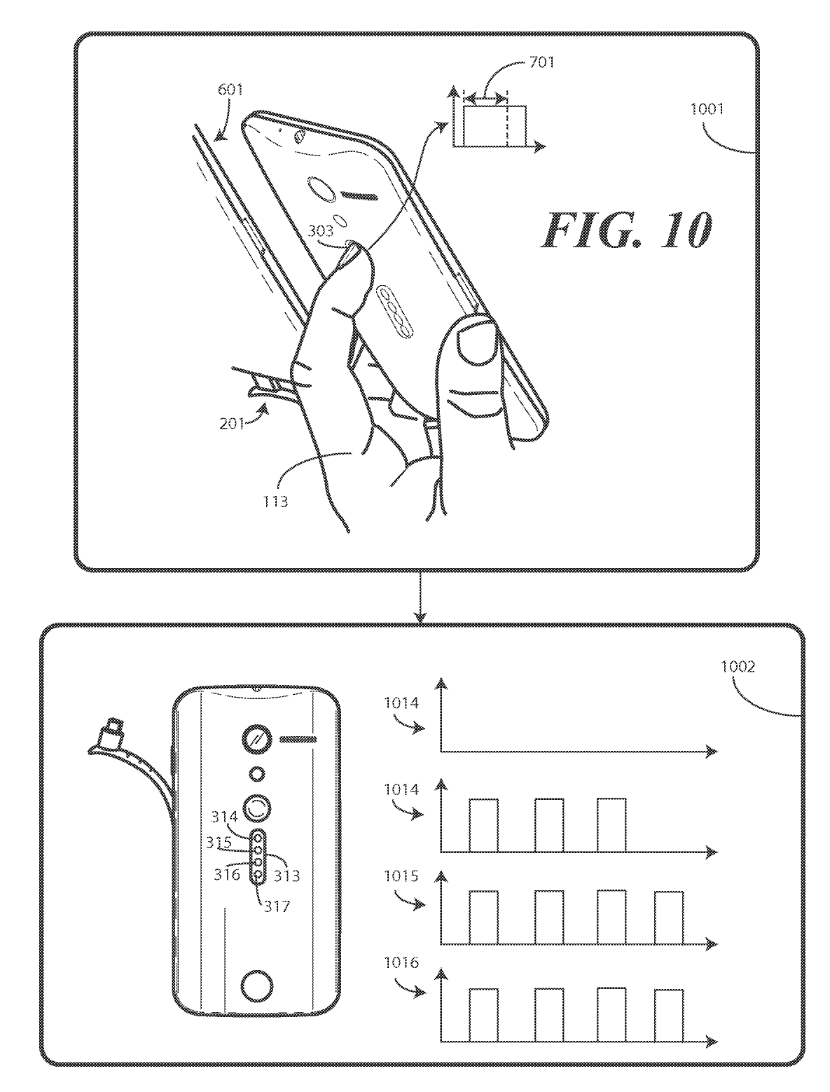

In one or more embodiments, the electronic device 100 also includes an energy capacity indicator 313 that is operable with the energy storage device 301. In this illustrative embodiment, the energy capacity indicator 313 comprises a plurality of lights 314,315,316,317, each of which is configured as a light emitting diode. As will be described in more detail below, in one embodiment the energy capacity indicator 313 is to present a first visible indication to the user 113 that is indicative of the amount of energy stored in the energy storage device 301 in a first operational mode. However, the energy capacity indicator 313 can be configured to also be configured to present a second indication in a second operational mode occurring when the electronic device is sharing energy through the power interface 201 with another device. In one embodiment, the second indication indicates both the amount of stored energy in the energy storage device 301 and indicia demonstrating that power delivery is occurring to another device through the power interface 201. As will be described with reference to FIGS. 9 and 10 below, in one embodiment the first indication comprises illuminating each of the plurality of lights 314,315,316,317 for different durations, while the second indicator comprises flashing each of, or alternatively each of a subset of, the plurality of lights 314,315,316,317 simultaneously. Where the subset is used, the size of the subset can indicate the amount of energy stored within the energy storage device 301 while the flashing indicates energy sharing with another electronic device through the power interface 201. Other conventions for doing the same will be obvious to those of ordinary skill in the art having the benefit of this disclosure.

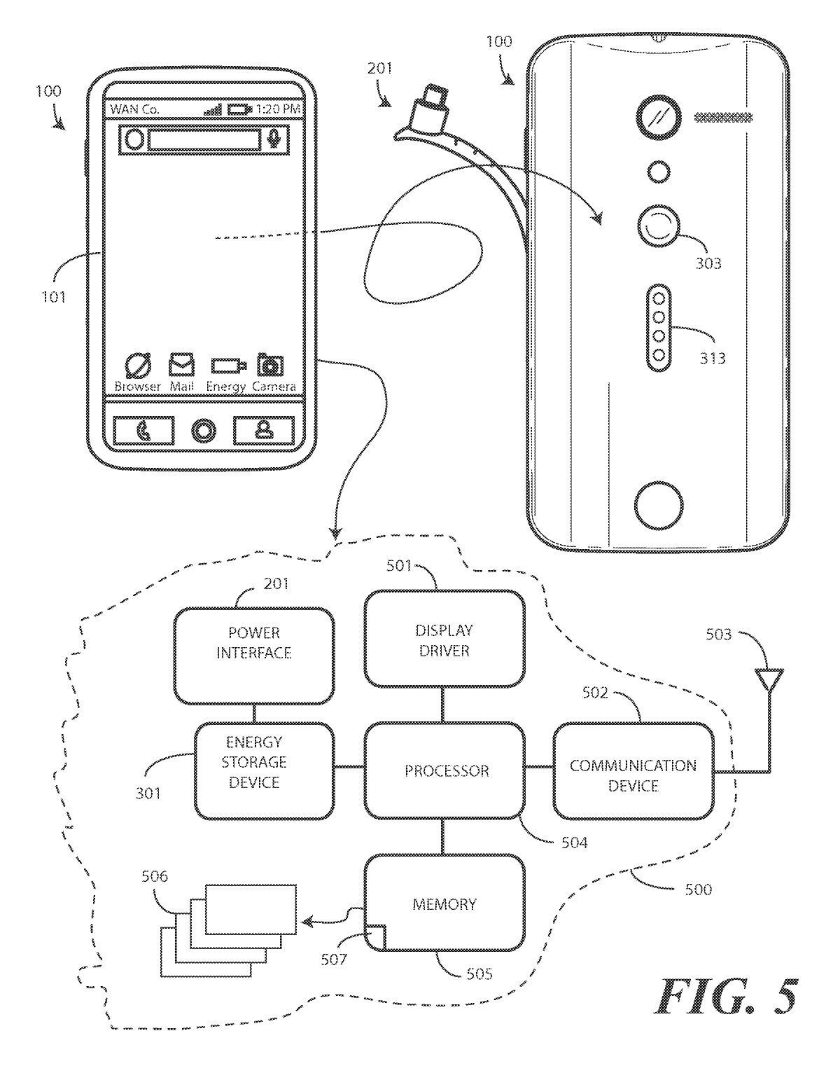

Turning now to FIG. 5, illustrated therein is the electronic device 100 with a block diagram schematic 500. As shown in FIG. 5, the electronic device 100 includes the touch-sensitive display 101, control button 303, the energy capacity indicator 313, and the power interface 201 described above.

As shown in the block diagram schematic 500, in one embodiment the electronic device 100 includes a display driver 501 that is operable with the touch-sensitive display 101. In this illustrative embodiment, the electronic device 100 also includes a communication circuit 502 that can be configured for wired or wireless communication with one or more other devices or networks. The networks can include a wide area network, a local area network, and/or personal area network. The communication circuit 502 can include wireless communication circuitry, one of a receiver, a transmitter, or transceiver, and one or more antennas 503.

The electronic device 100 includes a control circuit 504, which can include one or more processors. The control circuit 504 can be responsible for performing the various functions of the electronic device 100. For example, in one embodiment, the control circuit 504 is operable with the control button 303 to detect touch actuation from a user (113). The control circuit 504 can be a microprocessor, a group of processing components, one or more Application Specific Integrated Circuits (ASICs), programmable logic, or other type of processing device. The control circuit 504 can be operable with the various components of the electronic device 100, including the touch-sensitive display 101 and the communication circuit 502, as well as the power interface 201, which can be coupled to peripheral hardware devices to share energy from the energy storage device 301.

The control circuit 504 can be configured to process and execute executable software code to perform the various functions of the electronic device 100. A storage device, such as memory 505, stores the executable software code used by the control circuit 504 for device operation. The executable software code used by the control circuit 504 can be configured as one or more modules 506 that are operable with the control circuit 504. Such modules 506 can store instructions, control algorithms, and so forth. The instructions can instruct processors or control circuit 504 to perform the various steps for sharing energy from the energy storage device 301 as described herein.

In one embodiment, the control circuit 504 is operable with the energy storage device 301. As noted above, in one embodiment the energy storage device 301 is a rechargeable battery. For example, in one embodiment the energy storage device 301 can be a lithium-ion rechargeable battery. Lithium-ion cells are popular choices for use in batteries of many portable electronic devices. However, it will be clear to those of ordinary skill in the art having the benefit of this disclosure that other cell types could also be used with the energy storage device 301. For example, rather than using a lithium-ion cell, a lithium-polymer cell could be used.

In one embodiment, the energy storage device 301 comprises at least one cell having an anode, a cathode, and one or more separator layers. The anode serves as the negative electrode, while the cathode serves as the positive electrode. The separator layers prevent these two electrodes from physically contacting each other. While the separator layers physically separate the cathode from the anode, the separator layers permit ions to pass from the cathode to the anode and vice versa so the energy storage device 301 can be charged or discharged.

In one embodiment, the anode and cathode each comprise a foil layer coated with an electrochemically active material. For example, the anode can include a copper foil layer that is coated with graphite in one embodiment. The cathode can include an aluminum foil layer that is coated with Lithium Cobalt Dioxide (LiCoO.sup.2). The separator layers electrically isolate the anode from the cathode, and comprise a polymer membrane in one or more embodiments.

The electrode assembly of the energy storage device 301 can be placed in an electrolyte. In one embodiment, the electrolyte is an organic electrolyte and provides an ionic conducting medium for lithium ions to move between the anode and cathode during charge and discharge of the energy storage device 301. The anode, cathode, and separator layers can be either wound in a jellyroll configuration or cut and stacked.

As noted above, in one embodiment the power interface 201 is operable with the energy storage device 301. In one or more embodiments, the power interface 201 can be used to share energy stored within the energy storage device 301 with another electronic device. Optionally, the power interface 201 can be used to charge the energy storage device 301 as well. However, some embodiments, the power interface 201 will only be used to share energy with another device, and a separate charging connector (not shown) will be included for charging operations.

As noted above, the control button 303 can comprise a user interface for the electronic device 100. In one or more embodiments, the control button 303 is operable with the control circuit 504. A user (113) can employ the control button 303 to initiate energy sharing with another device. For example, in one embodiment energy sharing is initiated when the user (113) presses or otherwise actuates the control button 303 for at least a predetermined duration, such as by holding down the control button 303 for one, two, or three seconds. Where the control button 303 is a touch-sensitive recessed feature instead of a push-button type control, the user (113) can touch the control button 303 for at least a predetermined duration to initiate the energy transfer. In one or more embodiments, the user (113) must continually press or otherwise actuate the control button 303 for the predetermined duration to initiate the energy transfer.

In one embodiment, the control circuit 504 is configured to determine that another device is coupled to the power interface 201. The control circuit 504 is further configured to detect user input occurring at the control button 303 for at least the predetermined duration. In one embodiment, the predetermined duration is at least three seconds, although other durations will be obvious to those of ordinary skill in the art having the benefit of this disclosure. In one embodiment, the control circuit 504 is configured to detect user input occurring at the control button 303 only when it occurs continuously for the predetermined duration.

In one embodiment, the control circuit 504 is configured to, in response to the user input occurring—or occurring continuously—for the predetermined duration, cause the energy storage device 301 to deliver a portion of energy stored therein to the device coupled to the power interface 201 through the power interface 201. In one embodiment, the control circuit 504 is configured to receive user instructions to define the portion to be delivered. For example, in one embodiment the portion delivered from the energy storage device 301 to the device coupled to the power interface 201 is defined by a predetermined current form the energy storage device 301 through the power interface 201 for a predetermined time. The user (113) may want to deliver 100 milliamps for ten minutes for example. In another embodiment, the portion of energy can be defined by a predetermined percentage of a state of charge of the energy storage device prior to the user input occurring at the control button 303. The user (113) may want to only deliver twenty percent of the their stored energy for example.

In one embodiment, the control circuit 504 is to cause the energy storage device 301 to deliver a portion of the energy stored therein to another device coupled to the power interface 201 in accordance with one or more user defined rules 507 received at the energy sharing application (107) and stored in the memory 505. As one example, the user (113) may want to share power with only select devices. Accordingly, the one or more user defined rules 507 may identify the devices with which energy may be shared.

The user defined rules 507 can take other forms as well. For example, in one embodiment, under a user defined capacity level, the control circuit 504 can be configured to reduce power sharing to a percent of remaining capacity. For instance, if only 800 milliamp-hours of energy remains in the energy storage device 301, the user defined rules 507 may limit the amount that can be transferred to only a predefined percentage, such as fifty percent or 400 milliamp-hours. In another embodiment, the user defined rules 507 may cause the control circuit 504 to terminate energy sharing if the energy stored within the energy storage device 301 falls below a predetermined threshold, such as thirty percent of total available capacity.

In one or more embodiments, the user defined rules 507 can cause the control circuit 504 to disable the energy-sharing feature by default when the electronic device 100 is powering ON. In one or more embodiments, the user defined rules 507 can cause the control circuit 504 to disable the energy sharing feature when the power mode of the electronic device 100 changes. For example, if an external power supply is connected to, or alternatively disconnected from, the electronic device 100, in one or more embodiments the control circuit 504 can terminate the energy sharing feature in accordance with the user defined rules 507.

In one or more embodiments, the user defined rules 507 can preclude the control circuit 504 from entering the energy sharing mode, even when the control button 303 is actuated for at least the predetermined duration. For example, in one embodiment the user (113) may not want the energy sharing mode operational whenever the amount of energy stored in the energy storage device 301 is below a predetermined threshold. However, the user defined rules 507 may allow the user (113) to override this limitation—or any of the other limitations described above in other embodiments—by actuating the control button 303 a second time for at least the predetermined duration.

In one or more embodiments, the user defined rules 507 may automatically launch an energy sharing application (107) when the control button 303 is actuated for at least a predetermined duration. In one or more embodiments, the user defined rules may automatically close the energy sharing application (107) when sharing is complete. The user defined rules 507 set forth above are illustrative examples only, as other rules will be obvious to those of ordinary skill in the art having the benefit of this disclosure.

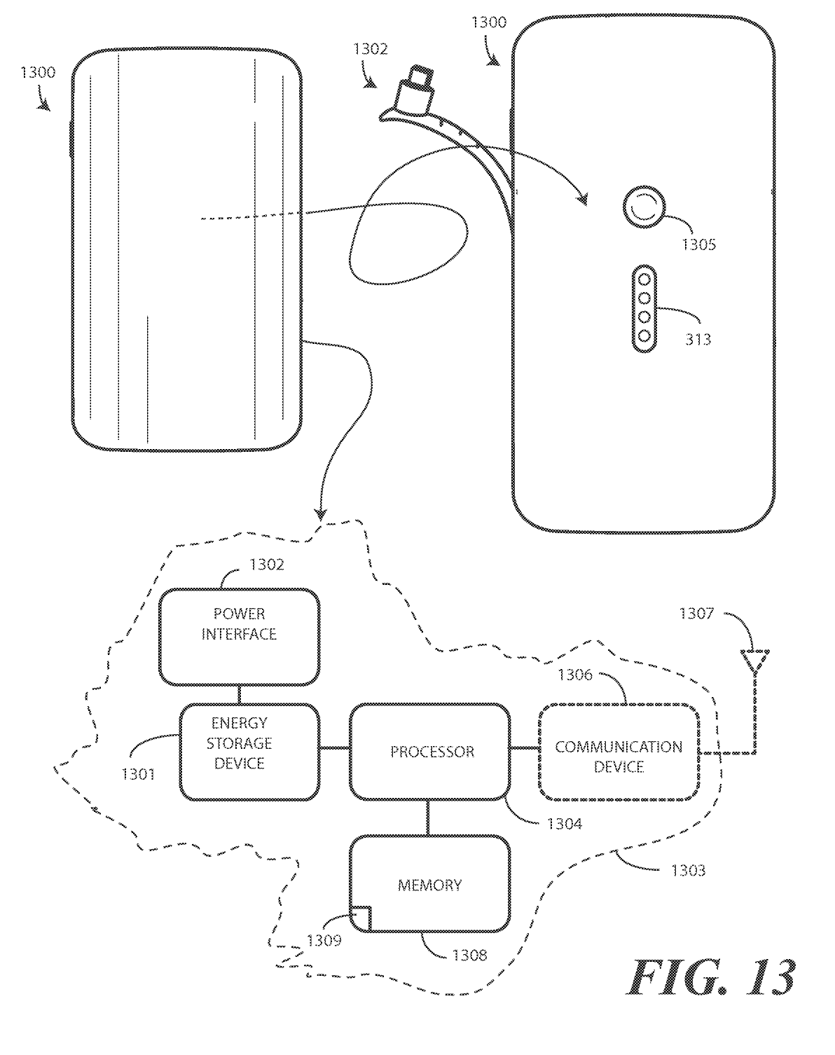

As noted above, the explanatory electronic device 100 of FIG. 5 is shown as a smart phone for illustrative purposes. However, it will be obvious to those of ordinary skill in the art having the benefit of this disclosure that other electronic devices may be substituted for the explanatory smart phone of FIG. 5. Turning briefly to FIG. 13, illustrated therein is a device 1300 that has as its dedicated function power sharing. However, rather than completely discharging its energy storage device 1301, it can discharge only a portion of the energy stored therein. Moreover, when equipped with an optional communication circuit, it can determine whether a receiving device is authorized for power sharing prior to delivering energy through the power interface 1302.

As shown in the block diagram schematic 1303, in one embodiment the electronic device 1300 a control circuit 1304, which can include one or more processors. The control circuit 1304 can be responsible for performing the various functions of the electronic device 1300. For example, in one embodiment, the control circuit 1304 is operable with the control button 1305 to detect touch actuation from a user (113). The control circuit 1304 can be a microprocessor, a group of processing components, one or more Application Specific Integrated Circuits (ASICs), programmable logic, or other type of processing device. The control circuit 1304 can be operable with the various components of the electronic device 1300, including an optional communication circuit 1306, as well as the power interface 1302, which can be coupled to peripheral hardware devices to share energy from the energy storage device 1301.

The control circuit 1304 can be configured to process and execute executable software code to perform the various functions of the electronic device 1300. A storage device, such as memory 1308, stores the executable software code used by the control circuit 1304 for device operation. The instructions can instruct processors or control circuit 1304 to perform the various steps for sharing energy from the energy storage device 1301 as described herein.

In one embodiment, the control circuit 1304 is operable with the energy storage device 1301. As noted above, in one embodiment the energy storage device 1301 is a rechargeable battery. For example, in one embodiment the energy storage device 1301 can be a lithium-ion rechargeable battery. However, it will be clear to those of ordinary skill in the art having the benefit of this disclosure that other cell types could also be used with the energy storage device 1301.

The power interface 1302 is operable with the energy storage device 1301. In one or more embodiments, the power interface 1302 can be used to share energy stored within the energy storage device 1301 with another electronic device. Optionally, the power interface 1301 can be used to charge the energy storage device 1301 as well.

In this embodiment, the control button 1305 comprises the sole user interface for the electronic device 1300. The control button 1305 is operable with the control circuit 1304. A user (113) can employ the control button 1305 to initiate energy sharing with another device. For example, in one embodiment energy sharing is initiated when the user (113) presses or otherwise actuates the control button 1305 for at least a predetermined duration, such as by holding down the control button 1305 for one, two, or three seconds. Where the control button 303 is a touch-sensitive recessed feature instead of a push-button type control, the user (113) can touch the control button 1305 for at least a predetermined duration to initiate the energy transfer. In one or more embodiments, the user (113) must continually press or otherwise actuate the control button 1305 for the predetermined duration to initiate the energy transfer.

In one embodiment, the control circuit 1304 is configured to determine that another device is coupled to the power interface 1302. The control circuit 1304 is further configured to detect user input occurring at the control button 1305 for at least the predetermined duration. In one embodiment, the predetermined duration is at least three seconds, although other durations will be obvious to those of ordinary skill in the art having the benefit of this disclosure. In one embodiment, the control circuit 1304 is configured to detect user input occurring at the control button 303 only when it occurs continuously for the predetermined duration.

In one embodiment, the control circuit 1304 is configured to, in response to the user input occurring—or occurring continuously—for the predetermined duration, cause the energy storage device 1301 to deliver a portion of energy stored therein to the device coupled to the power interface 1302 through the power interface 1302. In one embodiment, the control circuit 1304 is configured to receive user instructions to define the portion to be delivered. For example, in one embodiment the portion delivered from the energy storage device 1301 to the device coupled to the power interface 1302 is defined by a predetermined current form the energy storage device 1301 through the power interface 1302 for a predetermined time. The user (113) may want to deliver 100 milliamps for ten minutes for example. In another embodiment, the portion of energy can be defined by a predetermined percentage of a state of charge of the energy storage device prior to the user input occurring at the control button 1305. The user (113) may want to only deliver twenty percent of the their stored energy for example.

In one embodiment, the control circuit 1304 is to cause the energy storage device 1301 to deliver a portion of the energy stored therein to another device coupled to the power interface 1302 in accordance with one or more user defined rules 1309 received from the optional communication device 1306 and stored in the memory 1308. As one example, the user (113) may want to share power with only select devices. Accordingly, the one or more user defined rules 1309 may identify the devices with which energy may be shared. Identification of authorized devices can be done in a variety of ways. Illustrating by example, the user defined rules 1309 identifying what other devices are permitted to share energy can be defined by device identifiers, e.g., serial numbers, service identifiers, e.g., telephone numbers or email addresses, or social identifiers, e.g., whether the user of the other device is “friends” or otherwise connected to the user (113). Where the device with which energy is to be shared is selected based upon a user profile or social networking profile, the sharing device can identify or detect this profile by wireless communication protocols through the optional communication circuit 1306 and corresponding antenna 1307. The wireless communication protocols can include near field communication, Bluetooth, Smart Bluetooth, and so forth. Other identifiers will be obvious to those of ordinary skill in the art having the benefit of this disclosure. The user defined rules 507 can take other forms as well as noted above with reference to FIG. 5.

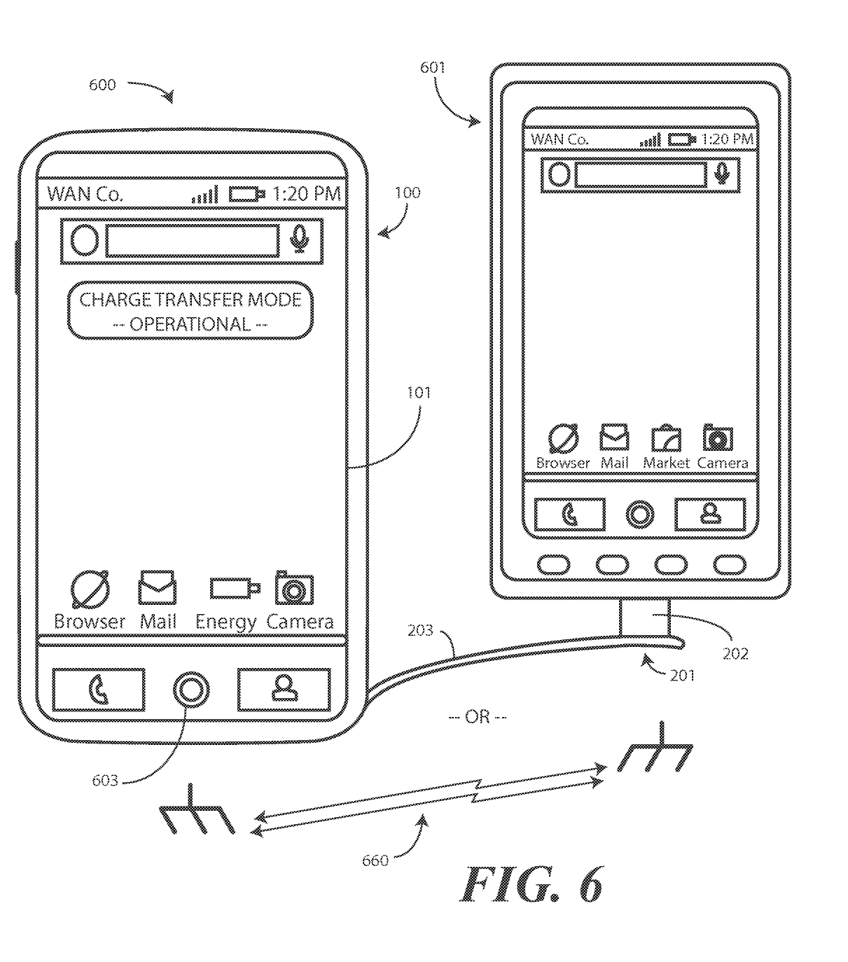

Turning now to FIG. 6, illustrated therein is a system 600 configured in accordance with one or more embodiments of the disclosure. A first device, shown here as electronic device 100, includes a power interface 201. In this illustrative embodiment, for continuity of illustration, the power interface 201 comprises a flexible cable 203 and a mini-USB connector 202. However, it will be obvious to those of ordinary skill in the art having the benefit of this disclosure that embodiments are not so limited. For example, power interface 201 can comprise a wireless connection 660 instead of the physical connector defined by the flexible cable 203 and mini-USB connector 202.

As noted above, the electronic device 100 includes an energy storage device (301) that is operable with the power interface 201. Further, the electronic device 100 includes a control circuit (504) that is operable with the energy storage device (310).

A second device 601, illustrated here as another smart phone, is coupled to the power interface 201. In this illustrative embodiment, the control circuit (504) is configured to detect actuation of a user input device, which can be a user actuation target 603 presented on the touch-sensitive display 101 in one embodiment. In one embodiment, the control circuit (504) is configured to detect this actuation for at least a predetermined duration, such as for at least three seconds. In one embodiment, the control circuit (504) is then to cause the energy storage device (301) to deliver a portion of its stored energy to the second device 601 through the power interface 201. In one or more embodiments, the delivery occurs in accordance with one or more user defined rules (507). For instance, in one embodiment the user defined rules (507) define which devices are authorized to receive energy from the energy storage device (301). As mentioned above, identification of authorized devices can be done in a variety of ways. Illustrating by example, the user defined rules (507) identifying what other devices are permitted to share energy can be defined by device identifiers, e.g., serial numbers, service identifiers, e.g., telephone numbers or email addresses, or social identifiers, e.g., whether the user of the other device is “friends” or otherwise connected to the user (113). Where the device with which energy is to be shared is selected based upon a user profile or social networking profile, the sharing device can identify or detect this profile by wireless communication protocols, including near field communication, Bluetooth, Smart Bluetooth, and so forth. Other identifiers will be obvious to those of ordinary skill in the art having the benefit of this disclosure. Accordingly, in one embodiment the control circuit (504) is to determine whether the second device 601 is permitted to receive the portion prior to causing the energy storage device (301) to deliver the portion.

As noted above, in one embodiment the user interface with which the user (113) initiates energy sharing is configured as a pressable control button (303). Turning now to FIG. 7, illustrated therein is the user 113 pressing the control button 303 for at least the predetermined duration 701 to transition the electronic device 100 into the energy sharing mode of operation. As shown in FIG. 7, the user 113 has pressed down the control button 303 with his finger 702 continuously for at least the predetermined duration 701 in this illustrative embodiment.

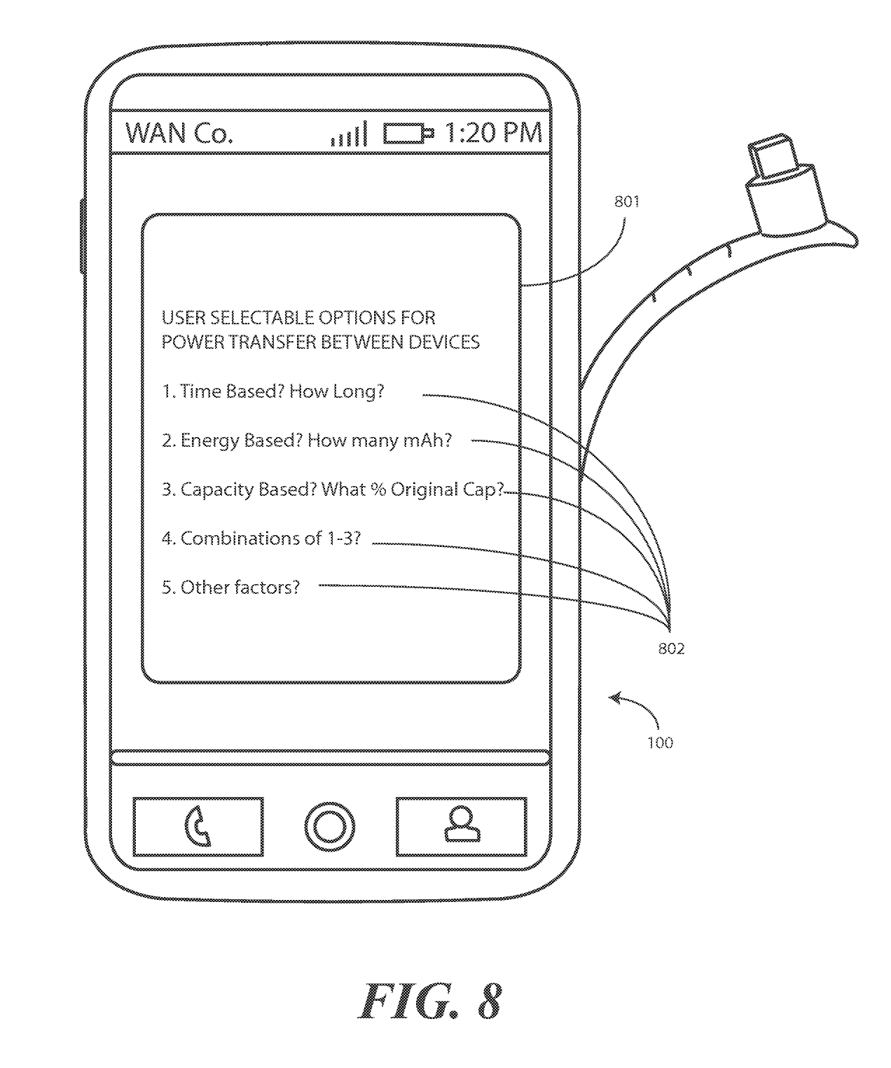

In one or more embodiments, when this occurs, the control circuit (504) is configured to present a notification to the user 113 that the electronic device 100 has entered the energy storing mode of operation. Turning briefly to FIG. 8, illustrated therein is one such notification 801, along with optional input information that can be used as the user defined rules (507) as previously described.

In one or more embodiments, the control button (303) comprises a multifunction control button configured to cause different modes of operation or functions to occur when the control button (303) is pressed for different amounts of time. For example, in one embodiment where the control button (303) is configured as a multifunction control button, the control circuit (504) of the electronic device 100 is to execute a function different from causing the energy storage device (301) to deliver the portion of energy to another device when the control button (303) is pressed less than the predetermined duration. FIGS. 9 and 10 illustrate one example of this.

Turning first to FIG. 9, at step 901 the control button 303 has been actuated by the user 113 for less than the predetermined duration 701. In this illustrative embodiment, this causes the control circuit (504) to enter a first mode of operation. In this example, the first mode of operation is a presentation of an amount of energy stored within the energy storage device (301). Accordingly, as shown at step 902, when the control button 303 is actuated for less than the predetermined duration 701, the control circuit (504) is to cause the energy capacity indicator 313 to present a first indication identifying the amount of energy stored within the energy storage device (301). In this embodiment, the first indication comprises illuminating each of the plurality of lights 314,315,316,317. As shown in the control diagrams 914,915,916,917, which correspond to lights 314,315,316,317, respectively, the first indication comprises illuminating each of the plurality of lights 314,315,316,317 for different durations.

In this illustrative embodiment, the energy storage device (301) is full. Accordingly, each of the lights 314,315,316,317 is illuminated. However, to indicate the first mode of operation they are illuminated for different durations. As shown in the control diagrams, 914,915,916,917, all four lights 314,315,316,317 are initially illuminated. However, light 314 goes off first, followed by light 315, and so forth. Had the energy storage device (301) been only eighty percent full, light 314 would not have illuminated in this illustrative embodiment. Only lights 315,316,317 would have initially been illuminated, with light 315 going off first, followed by light 316, and so forth.

By contrast, as shown in FIG. 10, at step 1001 the control button 303 has been actuated by the user 113 for more than the predetermined duration 701. In this illustrative embodiment, this causes the control circuit (504) to enter a second mode of operation. In this example, the second mode of operation is a presentation of both an amount of energy stored within the energy storage device (301) and indicia of power delivery to another device 601 through the power interface 201. Accordingly, as shown at step 1002, when the control button 303 is actuated for more than the predetermined duration 701, the control circuit (504) is to cause the energy capacity indicator 313 to present a second indication identifying the amount of energy stored within the energy storage device (301) and the fact that the electronic device 100 is in the second mode of operation. In this embodiment, the second indication comprises flashing at least some of the plurality of lights 314,315,316,317 simultaneously. As shown in the control diagrams 1014,1015,1016,1017, which correspond to lights 314,315,316,317, respectively, the second indication comprises flashing at least some of the plurality of lights 314,315,316,317 simultaneously.

In this illustrative embodiment, the energy storage device (301) is only eighty percent full initially. Accordingly, lights 315,316,317 are flashed simultaneously. However, since the electronic device is in the energy sharing mode, the energy storage device (301) is becoming depleted. Accordingly, to indicate when the energy storage device (301) falls below seventy-five percent, light 315 falls out of the flashing sequence as indicated in the right-most portion of control diagram 1015.

While FIGS. 9 and 10 illustrate actuation of the control button 303 for different durations to put the electronic device 100 in different operational modes, in one or more embodiments the control circuit (504) will automatically put the electronic device in the second mode when the control button 303 is pressed or otherwise actuated for at least the predetermined duration 701 regardless of what other function (if any) is triggered by actuating the control button 303 for less than the predetermined duration 701. Accordingly, in one or more embodiments the control circuit (504) is to cause the energy capacity indicator 313 to present a first visible indication prior to the user input occurring continuously for the predetermined duration 701 and a second indication after the user input occurring continuously for the predetermined duration 701. Other operational embodiments will be obvious to those of ordinary skill in the art having the benefit of this disclosure.

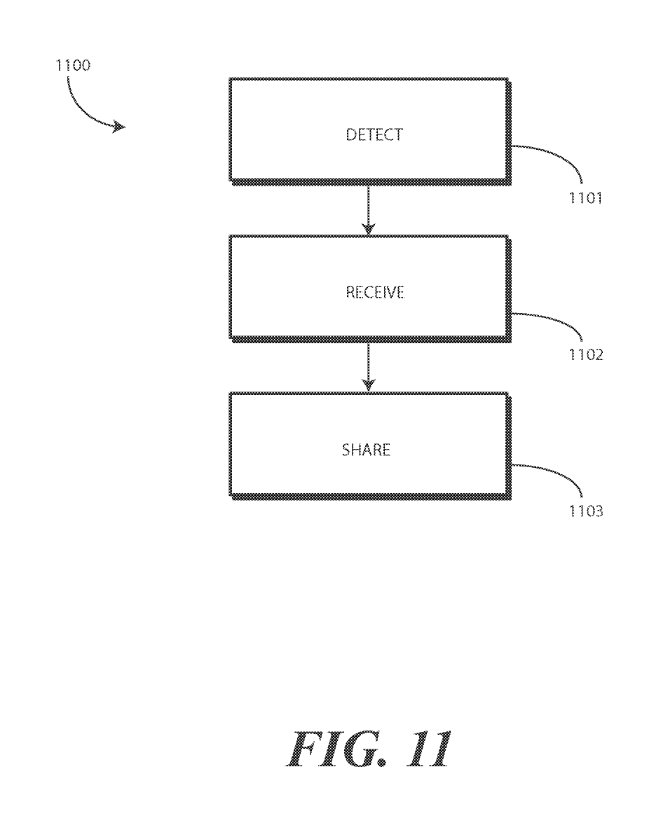

Turning now to FIG. 11, illustrated therein is one explanatory method 1100 for sharing energy from an electronic device in accordance with on or more embodiments of the disclosure. At step 1101, the method 1100 comprises detecting a device coupled to a power interface. In one embodiment, the detecting of step 1101 is performed with a control circuit.

At step 1102, the method 1100 comprises receiving actuation of a user input. In one embodiment, step 1102 comprises receiving the actuation for at least a predetermined duration. In one embodiment, step 1102 comprises receiving continuous actuation of the user input for at least the predetermined duration. In one embodiment, the actuation received at step 1102 is received from a user interface.

At step 1103, the method 1100 comprises, after receiving the continuous actuation of the user input for the at least a predetermined duration, sharing energy from an energy storage device. In one embodiment, the sharing occurring at step 1103 comprises sharing current with another device. In one embodiment, the current delivered at step 1103 occurs through a power interface. In one embodiment, the sharing occurring at step 1103 comprises sharing only a portion of the energy from the energy storage device with the device. Accordingly, in one embodiment step 1103 can further comprise receiving user instructions defining the portion. Further, step 1103 can additionally comprise user instructions defining one or more whether the device is permitted to share energy with the energy storage device, when to terminate the sharing, or combinations thereof.

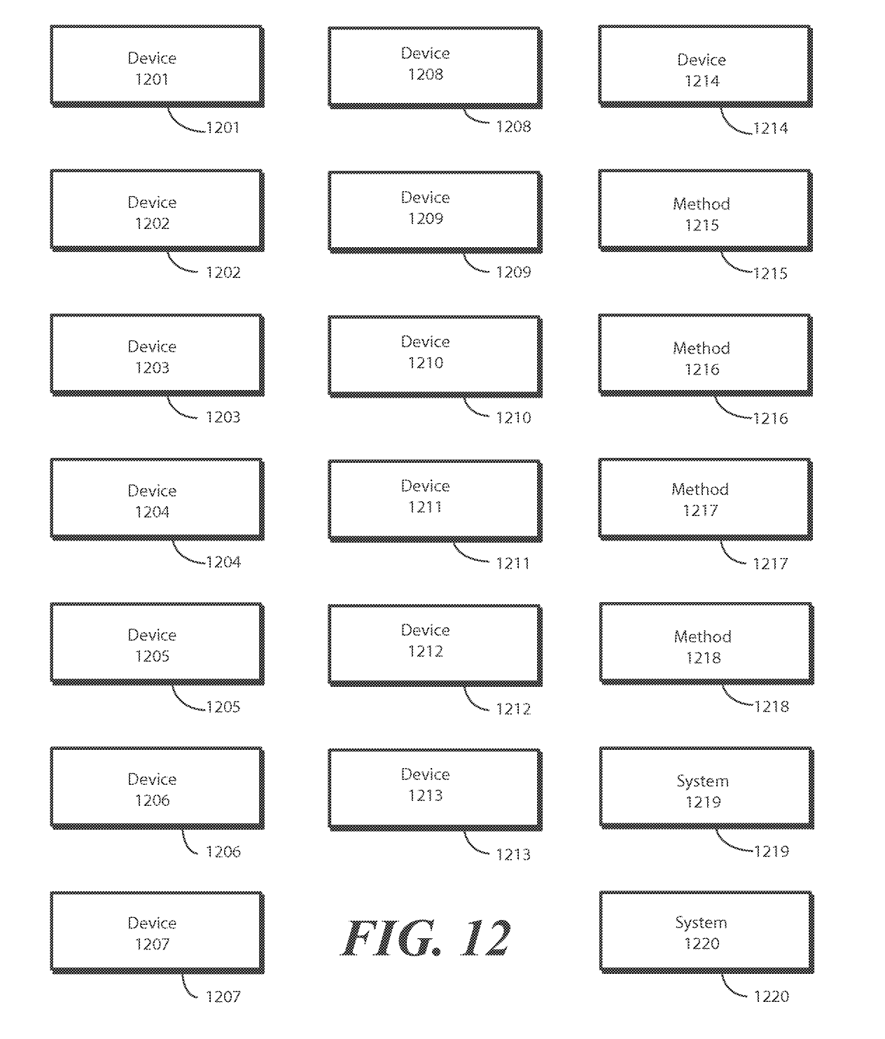

Turning now to FIG. 12, illustrated therein are various embodiments of the disclosure. Beginning at 1201, a device comprises a control circuit. In one embodiment, the device at 1201 comprises an energy storage device operable with the control circuit. In one embodiment, the device at 1201 comprises a power interface operable with the energy storage device. In one embodiment, the device at 1201 comprises a user interface operable with the control circuit. In one embodiment, the control circuit at 1201 is to determine another device coupled to the power interface. In one embodiment, the control circuit at 1201 is to detect user input occurring continuously at the user interface for at least a predetermined duration. In one embodiment, the control circuit at 1201 is to, in response the user input occurring continuously for the predetermined duration, cause the energy storage device to deliver a portion of energy stored therein to the another device through the power interface.

At 1202, the user interface of 1201 comprises a control button. At 1202, the user input of 1201 comprises pressing the control button.

At 1203, the control button of 1202 comprises a multifunction control button. At 1203, the control circuit of 1201 is to execute a function different from causing the energy storage device to deliver the portion of energy to the another device when the control button is pressed less than the predetermined duration.

At 1204, the predetermined duration of 1201 is at least three seconds. At 1205, the device of 1202 further comprises a touch sensitive display disposed along a first major face of the device. At 1205, the control button of 1202 is disposed on a second major face of the device disposed opposite the first major face.

At 1206, the device of 1201 further comprises an energy capacity indicator. At 1206, the energy capacity indicator is to present a first visible indication prior to the user input occurring continuously for the predetermined duration. At 1206, the energy capacity indicator is to present a second indication after the user input occurring continuously for the predetermined duration.

At 1207, the first indication of 1206 identifies an amount of stored energy in the energy storage device. At 1207, the second indication of 1206 identifies both the amount of stored energy in the energy storage device and indicia of power delivery to the another device through the power interface.

At 1208, the energy capacity indicator of 1207 comprises a plurality of lights. At 1208, the first indicator of 1206 comprises illuminating each of the plurality of lights for different durations. At 1208, the second indicator of 1206 comprises flashing the each of the plurality of lights simultaneously.

At 1209, the portion of energy at 1201 is defined by a predetermined current from the energy storage device through the energy interface for a predetermined time. At 1210, the portion of energy at 1201 is defined by a predetermined percentage of a state of charge of the energy storage device prior to the user input occurring continuously for the predetermined duration.

At 1211, the control circuit of 1201 is to cause the energy storage device to deliver a portion of energy stored therein to the another device through the power interface in accordance to one or more user defined rules. At 1212, the one or more user defined rules at 1211 identify the another device.

At 1213, the power interface of 1201 is stowable within a housing of the device when not coupled to the another device. At 1214, the power interface of 1213 comprises a mini-USB connector.

At 1215, a method comprises detecting, with a control circuit, a device coupled to a power interface. At 1215, the method comprises receiving, from a user input, continuous actuation of the user input for at least a predetermined duration. At 1215, and after receiving the continuous actuation of the user input for the at least a predetermined duration, the method comprises sharing energy from an energy storage device with the device by delivering current through the power interface.

At 1216, the sharing at 1215 comprises sharing only a portion of the energy from the energy storage device with the device. At 1217, the method of 1215 comprises receiving user instructions defining the portion. At 1218, the method of 1215 further comprises receiving user instructions defining one or more whether the device is permitted to share energy with the energy storage device, when to terminate the sharing, or combinations thereof.

At 1219, a system comprises a first device and a second device. At 1219, the first device comprises a power interface. At 1219, the first device comprises an energy storage device operable with the power interface. At 1219, the first device comprises a control circuit operable with the energy storage device. At 1219, the first device comprises a user input device operable with the control circuit. At 1219, the second device can be coupled to the power interface. In one embodiment, at 1219 the control circuit of the first device is to detect actuation of the user input device for at least a predetermined duration to cause the energy storage device to deliver a portion of its stored energy to the second device through the power interface. At 1220, the control circuit of 1219 is to determine whether the second device is permitted to receive the portion prior to causing the energy storage device to deliver the portion.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A device, comprising:
a control circuit;
an energy storage device operable with the control circuit;
a power interface operable with the energy storage device; and
a user interface operable with the control circuit;
the control circuit to:
determine another device coupled to the power interface;
detect user input occurring continuously at the user interface for at least a predetermined duration; and
in response the user input occurring continuously for the predetermined duration cause the energy storage device to deliver a portion of energy stored therein to the another device through the power interface.

2. The device of claim 1, the user interface comprising a control button, the user input comprising pressing the control button.

3. The device of claim 2, the control button comprising a multifunction control button, the control circuit to execute a function different from causing the energy storage device to deliver the portion of energy to the another device when the control button is pressed less than the predetermined duration.

4. The device of claim 2, the predetermined duration at least three seconds.

5. The device of claim 2, the device further comprising a touch sensitive display disposed along a first major face of the device, the control button disposed on a second major face of the device disposed opposite the first major face.

6. The device of claim 1, further comprising an energy capacity indicator to present a first visible indication prior to the user input occurring continuously for the predetermined duration and a second visible indication after the user input occurring continuously for the predetermined duration.

7. The device of claim 6, the first visible indication identifying an amount of stored energy in the energy storage device, the second visible indication both the amount of stored energy in the energy storage device and indicia of power delivery to the another device through the power interface.

8. The device of claim 7, the energy capacity indicator comprising a plurality of lights, the first visible indication comprising illuminating at least some of the plurality of lights for different durations, the second visible indication comprising flashing one or more of the plurality of lights simultaneously.

9. The device of claim 1, the portion of energy defined by a predetermined current from the energy storage device through the power interface for a predetermined time.

10. The device of claim 1, the portion of energy defined by a predetermined percentage of a state of charge of the energy storage device prior to the user input occurring continuously for the predetermined duration.

11. The device of claim 1, the control circuit to cause the energy storage device to deliver the portion of energy stored therein to the another device through the power interface in accordance to one or more user defined rules.

12. The device of claim 11, the one or more user defined rules identifying the another device.

13. The device of claim 1, the power interface stowable within a housing of the device when not coupled to the another device.

14. The device of claim 1, the power interface comprising a wireless interface.

15. A method, comprising:
detecting, with a control circuit, a device coupled to a power interface;
receiving, from a user input, continuous actuation of the user input for at least a predetermined duration; and
after receiving the continuous actuation of the user input for the at least a predetermined duration, sharing energy from an energy storage device with the device by delivering current through the power interface.

16. The method of claim 15, the sharing comprising sharing only a portion of the energy from the energy storage device with the device.

17. The method of claim 16, further comprising receiving user input defining the portion.

18. The method of claim 15, further comprising receiving user input defining one or more whether the device is permitted to share energy with the energy storage device, when to terminate the sharing, or combinations thereof.

19. A system, comprising:
a first device comprising:
a power interface;
an energy storage device operable with the power interface;
a control circuit operable with the energy storage device; and
a user input device operable with the control circuit; and
a second device coupled to the power interface;
the control circuit to detect actuation of the user input device for at least a predetermined duration to cause the energy storage device to deliver a portion of its stored energy to the second device through the power interface.

20. The system of claim 19, the control circuit to determine whether the second device is permitted to receive the portion prior to causing the energy storage device to deliver the portion.
